(19) United States
(12) Patent Application Publication
(10) Pub. No.: US 2024/0081527 A1
(43) Pub. Date: Mar. 14, 2024

(54) Storage Support Bracket

(71) Applicant: Boswell Patten, Port Saint. Lucie, FL (US)

(72) Inventor: Boswell Patten, Port Saint. Lucie, FL (US)

(73) Assignee: AHMENKI LLC, Lehigh Acres, FL (US)

(21) Appl. No.: 17/699,243

(22) Filed: Mar. 21, 2022

(51) Int. Cl. A47B 81/00; B25H 3/04

(52) U.S. Cl. CPC A47B 81/00; B25H 3/04

(57) ABSTRACT

A storage support bracket received weight by a hook with bolt connected to the storage support bracket to store item on the storage support bracket where the storage support bracket is place in the attic over a beam where two slot is place in the storage support bracket for the hook where it is use to hang or hold equipment or tools such as (e.g., the bicycle) over the storage support bracket as a storage device when the storage support bracket is mounted on a beam in the attic.

### FIELD

At least some embodiments of the disclosure relate generally to the field of storage support bracket and, more particularly but not limited to, providing storage on the storage support bracket as a storage device in response to weight from a user of a equipment via, (e.g., the bicycle) in which the bicycle is mounted on a hook where the hook bears the weight of the bicycle where the storage support bracket is placed over two beams in an attic for storage of personal equipment (e.g., the bicycle) using the bracket that is used as a storage support bracket. Furthermore the storage support bracket is equipped to have a shelf connected to the bracket where equipment (e.g., the tools or garden equipment) can be placed on the shelf as a storage device.

### BACKGROUND

The utility bar provides a convenient way for a person to store personal equipment on the storage support bracket by placing the bracket in a location to save space in the person's garage, mechanic shop or in a person home in the attic where a person can have ample space where they never able to have before in a normal storage space. People can use the storage support bracket to store any kind of equipment from a (e.g., the bicycle, tools, landscape equipment).

### BRIEF DESCRIPTION OF THE DRAWINGS

The embodiments are illustrated by way of example and not limitation in the figures of the accompanying drawings in which like references indicate similar elements.

FIG. 1 shows two bracket including a slot on both ends of each bracket accessible by a bolt connected to a hook where a shelf is placed on the hooks to the bracket where a pin is located on both end of each bracket at the bottom of the bracket to hold the storage support bracket in place where the storage support bracket would be placed over a beam located in an attic according to one embodiment.

FIG. 2 shows a screenshot of the side shot of one of the storage support brackets including a width of the slot on top of the bracket along with the curve and diameter of the bracket connection to the storage support bracket of FIG. 1 according to one embodiment.

FIG. 3 shows a screenshot along with the curve and diameter of the hook by itself without any connection to the storage support bracket of FIG. 1 according to one embodiment.

FIG. 4 shows a screenshot of two bolts presenting a hook that is used to connect to one of the storage support brackets of FIG. 1 according to one embodiment.

FIG. 5 shows a screenshot of a pin that is used to prevent the bracket from moving in place with the pin presenting a connection to the bottom of the storage support bracket of FIG. 1 according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Systems and methods to provide an storage on a device known as a storage support bracket provides a convenient way for a person to store personal equipment on the utility bar by placing the bar in a location to save a person personal space (e.g. the garage, mechanic shop, attic or in a person's home) are described herein. The disclosure includes methods and apparatuses which perform these methods, including storage device systems which perform these methods. Other features will be apparent from the accompanying drawings and from the detailed description which follows.

### SPECIFICATION

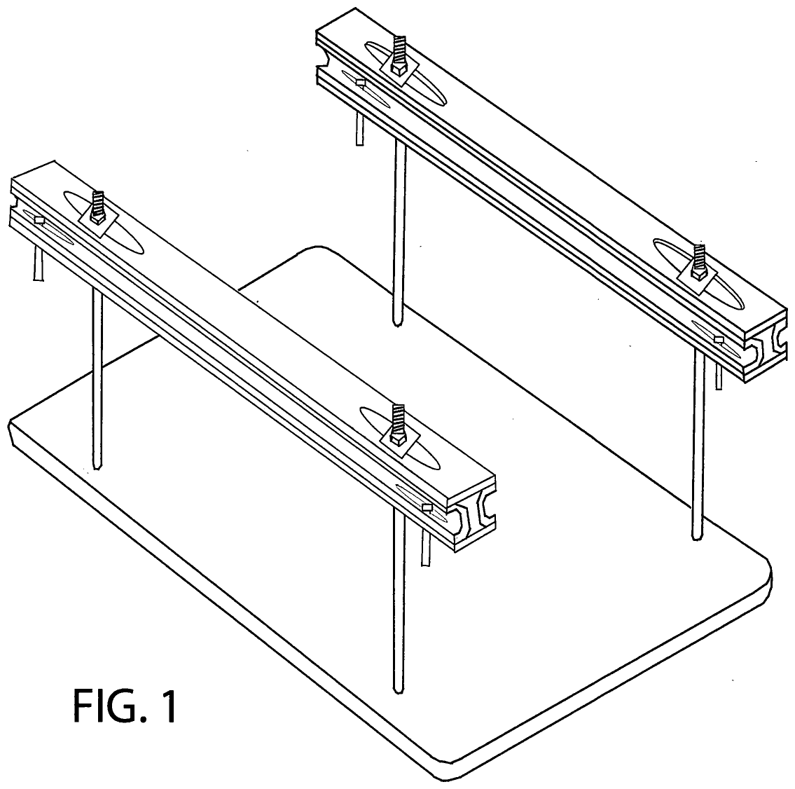

FIG. 1 shows a hook connected to a storage support bracket accessible by the user according to one embodiment. In FIG. 1, the device or storage support bracket is used to place over a beam in a user's personal space (e.g. the garage, mechanic shop, attic or in a person's home). The storage support bracket may include one or more hooks connected to a blot attached to the (2) two bracket where users can place (e.g. the tools, bicycle, hoses) on the bracket for storage.

The storage support bracket is connected to a beam where bolts on the bottom of the bar is use a bolt to hold firmly in place while over the beam in the attic as weight or item is placed on storage support bracket as a storage device in a facility (e.g. the garage, mechanic shop, attic or in a person's home) to store user personal item.

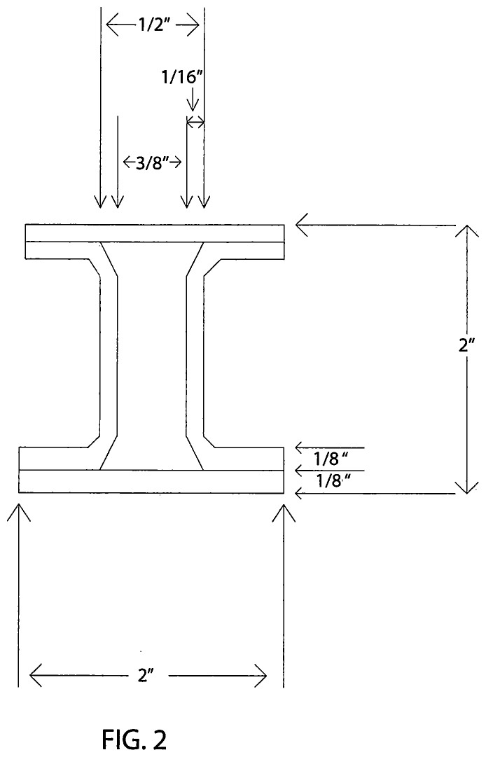

FIG. 2 shows a screenshot of a storage support bracket that presents a curve of the bracket with a width and height of the bracket illustrated at a 2 inch diameter of the width and height having a thickness of a (⅛) one-eighth of an inch of the bend bracket and a ⅛ thickness of the two straight bracket on top and on the bottom mended or molded together to create a solid storage support bracket according to one embodiment.

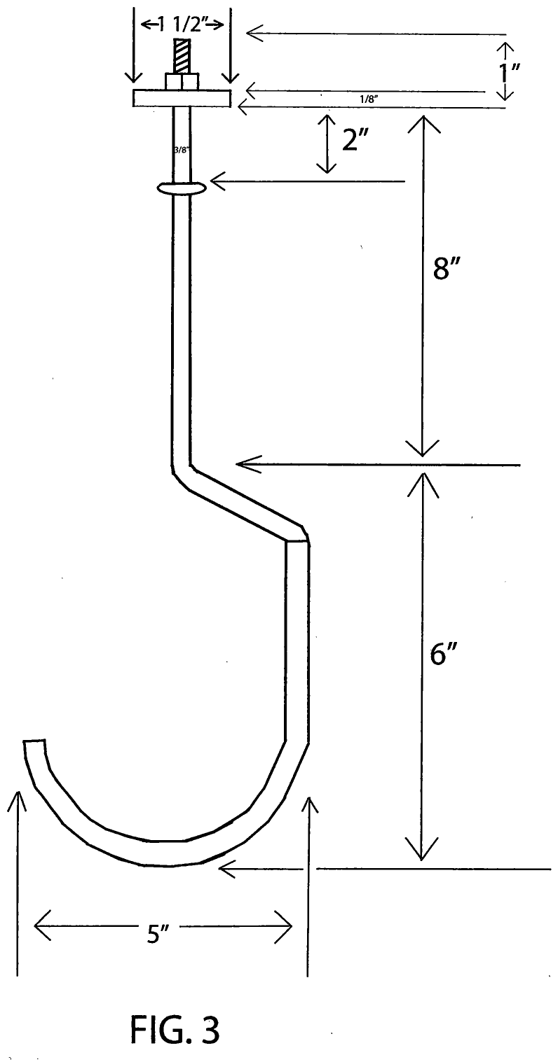

FIG. 3 shows a screenshot of a hook that is used to connect to the storage support bracket that devices (e.g. the tools, bicycle, hoses) can be place on the bracket as a storage device that has a dimension at the curve of the hook with a width of (5) five inches diameter at the end of the hook to the end of the curve with a dimension from the bottom of the hook that is curve to the other end of the hook that is curve at the top showing a dimension of (6) six inches in length with a (⅜) inches thickness of the hook discussed therein.

The dimension at the top of the hook where the thread is located as a diameter of (1) one inch in thread with a (1½) one and one-half inch length around the circumference for the square plate around the hook with a thickness of (⅛) one-eighth of an inch with a (½) half inch nut located around the hook to secure the hook to the storage support bracket. From the square plate to the start of the curve of the hook is (8) eight inches in length according to one embodiment.

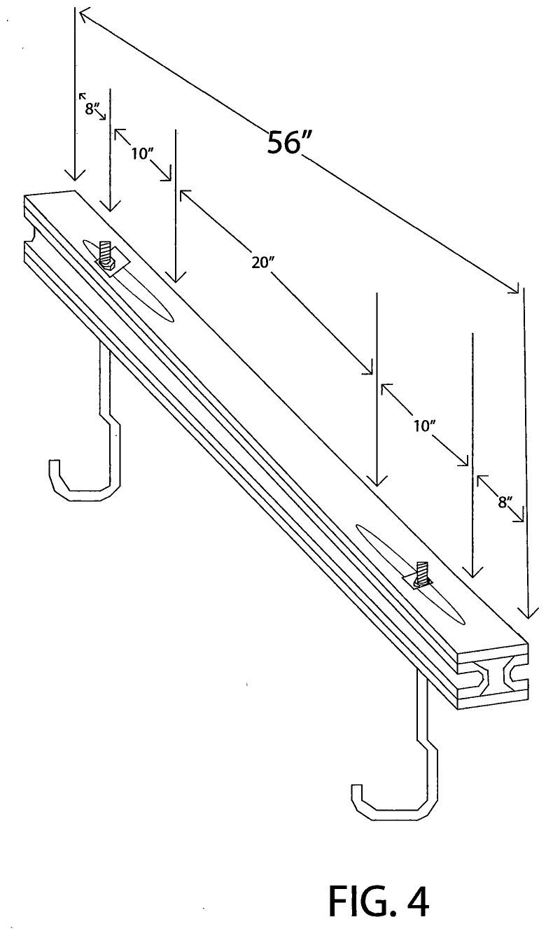

FIG. 4 shows a screenshot of a storage support bracket presenting a diameter in length of (56) fifty-six inches in length with a (8) eight inch length from the end of the bracket to the begin of the hole or slot located where the hook is connected at both ends discussed herein. The slot located on both ends is (10) ten diameters, where the end of both slots located in the center of the bracket for one end of one slot to the other end of the other slot is (20) twenty inch diameter in length according to one embodiment.

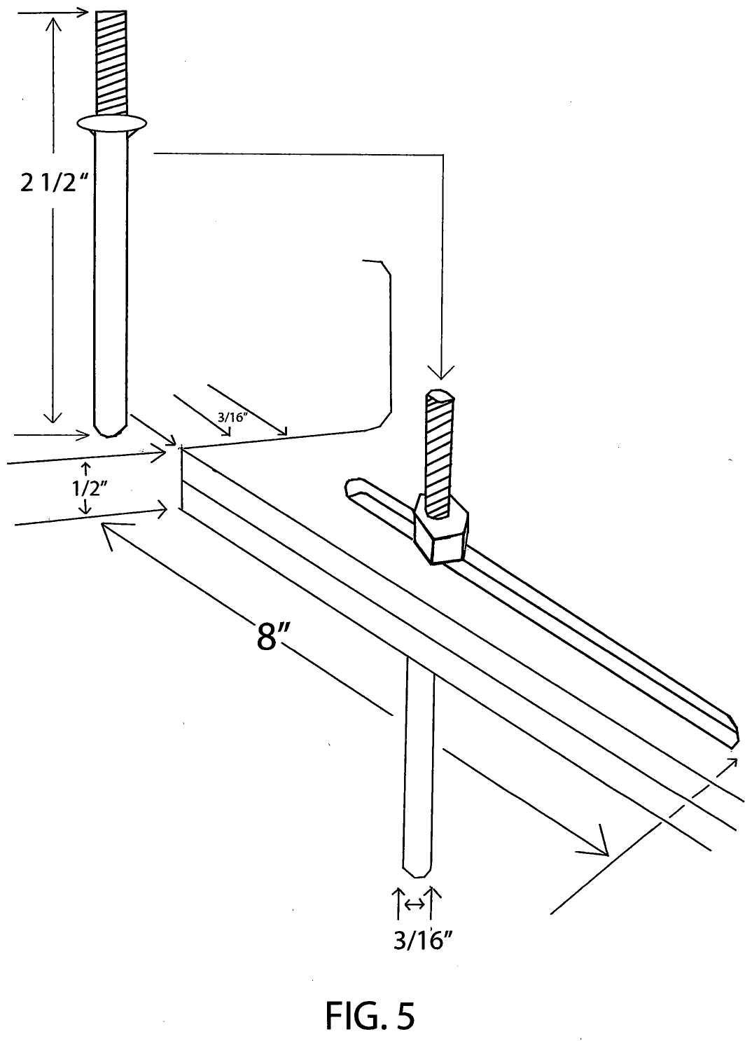

FIG. 5 shows a screenshot of a storage support bracket presenting a illustration of the bottom of the bracket where a bolt is used to connect the bracket to the beam over the attic in order to hold the bracket in place where items can now be place on the bracket as it is firmly hold in place in the attic in according to one embodiment.

The dimension at the bottom of the slot where the bolt is located as a diameter of (1) one inch in from the end to the begin of the slot where with of the slot is ( 3/16) with a length of the slot is (8) eight inches with a pin of a diameter of ( 3/16) pin to hold the bracket in place over the beam. The pin where the thread is located is of a (½) one-half inch length with the entire pin of (2½) pin. The nut that is connected to the pin is ( 3/16) circumference to secure the pin to the storage support bracket according to one embodiment.

What is claimed is:

1. A method, comprising: receiving, via a weight on a device know as a storage support bracket where the method of placing weight is used; via a hook that is curve with a bolt on the end that is attached to a utility rod or bar which is evenly place over two beam that is already present in the attic which comprising: via two slot that created in the storage support bracket that have a dimension; that is bend by molding the storage support bracket in a shape upon forming the curves in the shape where the slot receive support using a pin over a beam in the attic which; via the other slot, the second support on the other end of the storage support bracket which is design with a second pin in according to its dimension receive weight upon which item or equipment can be place via by a hook or via with a bolt that is place in the storage support bracket onto the slot that is in the center of both end of the storage support bracket in the dimension which is place between the two grove that is over the beam where item can be place on the beam as a storage device on the bracket that is place over the beam known as the storage support bracket.

2. The method of claim 1, wherein providing the storage support bracket with two slots on each end of the bar on the bottom of the bracket comprises presenting the pin to hold support over the beam where weight is distributed evenly over the bracket and respectively hold the storage support bracket in place in the attic for storage equipment to be place on the storage device.

3. The method of claim 1, further comprising storing a list of equipment and corresponding items, wherein the item is placed on the storage support bracket as a storage unit, that received weight on the storage support bracket where two slots is placed on each side of the bracket where a hook or bolt can place into the two slot or holes that hold weight on the bracket via, a bicycle or tools or garden equipment.

4. The method of claim 1, further comprising providing a tray of shelf on the two bracket where the shelf is bolted to two bracket having (4) four connection to the hook or bolt where a list of equipment and corresponding items, wherein the item is placed on the storage support bracket as a storage unit, that received weight on the storage device via, a bicycle or tools or garden equipment.

5. The method of claim 1, wherein the weight of object that is placed on the bolt where the end of the bolt have a hook that is attached to the bolt for item to be placed on the hook as it is bolt and mounted on the storage support bracket in the two slot, where item can be placed on the hook as a storage device to store equipment via bicycle or a tool on the hook that is connected to the bar.
